(19) United States
(12) Patent Application Publication
(10) Pub. No.: US 2023/0333011 A1
(43) Pub. Date: Oct. 19, 2023

(54) OPTICAL SYSTEM, METHODS OF FORMING AND OPERATING THE SAME

(71) Applicant: Agency for Science, Technology and Research, Singapore (SG)

(72) Inventors: Kapil Dev, Singapore (SG); Ruochong Zhang, Singapore (SG); Chi Lok Wong, Singapore (SG); Shuyan Zhang, Singapore (SG); Dinish Unnimadhava Kurup Soudamini Amma, Singapore (SG); Malini Carolene Devapiriyai Olivo, Singapore (SG)

(21) Appl. No.: 18/024,873

(22) PCT Filed: Sep. 15, 2021
(86) PCT No.: PCT/SG2021/050556

§ 371 Date: Mar. 6, 2023

(30) Foreign Application Priority Data
Sep. 18, 2020 (SG) 10202009155S

(51) Int. Cl. G01N 21/3563; G01N 21/64; G01N 21/84; G01N 21/359

(52) U.S. Cl. CPC G01N 21/3563; G01N 21/6456; G01N 21/84; G01N 21/359; G01N 2201/062; G01N 2201/08; G01N 2021/8466

(57) ABSTRACT

An optical system for imaging. The optical system includes light emitting diodes to provide light of predetermined wavelengths. The optical system further includes a charge-coupled device to receive the light emitted by one or more light emitting diodes and reflected by an object for fluorescence imaging of the object. The optical system additionally includes a broadband light source to provide broadband light. Furthermore, the optical system includes a spectrometer to receive the broadband light emitted by the broadband light source and reflected by the object for visible-near infrared-shortwave infrared spectroscopy of the object. Additionally, the optical system includes a hyperspectral camera to receive the broadband light emitted by the broadband light source and reflected by the object for hyperspectral imaging of the object as well as a controller coupled to the light emitting diodes, the broadband light source, the charge-coupled device, the spectrometer and the hyperspectral camera.

### CROSS-REFERENCE TO RELATED APPLICATION

This application claims the benefit of priority of Singapore application No. 10202009155S filed Sep. 18, 2020, the contents of it being hereby incorporated by reference in its entirety for all purposes.

### TECHNICAL FIELD

Various embodiments of this disclosure may relate to an optical system. Various embodiments of this disclosure may relate to a method of forming an optical system. Various embodiments of this disclosure may relate to a method of operating an optical system.

### BACKGROUND

Current imaging and sensing methods applied to indoor/outdoor vegetable and fruit farms, such as thermographic cameras, provide basic plant morphology and health status. Existing sensor solutions in the market provide limited measurement and are often contact-based, whereas lab-based chemical and analytical methods are accurate but are time-consuming.

### SUMMARY

Various embodiments may relate to an optical system. The optical system may include a plurality of light emitting diodes configured to provide light of predetermined wavelengths. The optical system may also include a charge-coupled device configured to receive the light emitted by one or more light emitting diodes of the plurality of light emitting diodes and reflected by an object for fluorescence imaging of the object. The optical system may further include a broadband light source configured to provide broadband light. The optical system may additionally include a spectrometer configured to receive the broadband light emitted by the broadband light source and reflected by the object for visible-near infrared-shortwave infrared spectroscopy of the object. The optical system may also include a hyperspectral camera configured to receive the broadband light emitted by the broadband light source and reflected by the object for hyperspectral imaging of the object. The optical system may further include a controller coupled to the plurality of light emitting diodes, the broadband light source, the charge-coupled device, the spectrometer and the hyperspectral camera.

Various embodiments may relate to a method of forming an optical system. The method may include providing a plurality of light emitting diodes configured to provide light of predetermined wavelengths. The method may also include providing a charge-coupled device configured to receive to receive the light emitted by one or more light emitting diodes of the plurality of light emitting diodes and reflected by an object for fluorescence imaging of the object. The method may additionally include providing a broadband light source configured to provide broadband light. The method may also include providing a spectrometer configured to receive the broadband light emitted by the broadband light source and reflected by the object for visible-near infrared-shortwave infrared spectroscopy of the object. The method may further include providing a hyperspectral camera configured to receive the broadband light emitted by the broadband light source and reflected by the object for hyperspectral imaging of the object. The method may also include coupling a controller to the plurality of light emitting diodes, the broadband light source, the charge-coupled device, the spectrometer and the hyperspectral camera.

Various embodiments may relate to a method of operating an optical system. The method may include providing light of predetermined wavelengths using one or more light emitting diodes of a plurality of light emitting diodes such that the light emitted by the one or more light emitting diodes of the plurality of light emitting diodes is reflected by an object and received by a charge-coupled device for fluorescence imaging of the object. The method may also include providing a broadband light using a broadband light source such that the broadband light emitted by the broadband light source is reflected by the object, wherein the reflected broadband light is received by a spectrometer for visible-near infrared-shortwave infrared spectroscopy of the object, and is received by a hyperspectral camera for hyperspectral imaging of the object.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 is a general illustration of an optical system according to various embodiments.

FIG. 2 is a general illustration of a method of forming an optical system according to various embodiments.

FIG. 3 is a general illustration of a method of operating an optical system according to various embodiments.

FIG. 4A shows a schematic of the integrated optical system according to various embodiments for plant phenotyping.

FIG. 4B is a schematic showing the optical system being used for fluorescence imaging according to various embodiments.

FIG. 4C shows (a)-(e) photographs of a Chye Sim leaf taken from Day 1 to Day 5, and (f)-(j) the corresponding fluorescence images (750±20 nm) images using the charge-coupled device (CCD) 404 of the optical system according to various embodiments.

FIG. 4D shows a plot of average intensity (in arbitrary units or a.u.) as a function of day illustrating the variation of the average intensity of the fluorescence images according to various embodiments.

FIG. 4E is a schematic showing the optical system being used for visible-near infrared-shortwave infrared (VIS-NIR-SWIR) spectroscopy according to various embodiments.

FIG. 4F is a plot of normalized reflectance as a function of wavelength (in nanometer or nm) showing the visible-near infrared-shortwave infrared (VIS-NIR-SWIR) spectra collected over four days at eight different weight data points by the optical system according to various embodiments before and after heat treatment from one of the Bok Chye leaves.

FIG. 4G is a plot of weight (in grams or gins) as a function of weight data points showing the weight of the Bok Chye leaf at different weight data points.

FIG. 4H is a schematic showing a method of determining different macro-nutrient contents of the plant 414 according to various embodiments.

FIG. 4I is a schematic showing the optical system being used for hyperspectral imaging (HSI) according to various embodiments.

FIG. 4J is a plot of nitrogen (N) percentage (%) as a function of intensity unit (arbitrary units) showing the measured calibration curve for nitrogen in the leaf sample according to various embodiments.

FIG. 4K is a plot of phosphorous (P) percentage (%) as a function of intensity unit (arbitrary units) showing the measured calibration curve for phosphorous in the leaf sample according to various embodiments.

FIG. 4L is a plot of potassium (K) percentage (%) as a function of intensity unit (arbitrary units) showing the measured calibration curve for potassium in the leaf sample according to various embodiments.

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the systems or methods are analogously valid for the other systems or methods. Similarly, embodiments described in the context of a method are analogously valid for a system, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Various embodiments may seek the address the various issues faced by conventional systems.

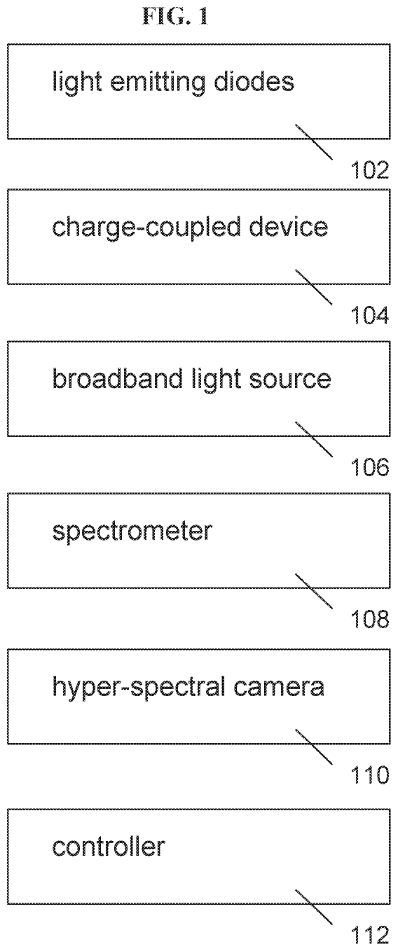

FIG. 1 is a general illustration of an optical system according to various embodiments. The optical system may include a plurality of light emitting diodes 102 configured to provide light of predetermined wavelengths. The optical system may also include a charge-coupled device (CCD) 104 configured to receive the light emitted by one or more light emitting diodes of the plurality of light emitting diodes (LEDs) 102 and reflected by an object for fluorescence imaging (FI) of the object. The optical system may further include a broadband light source 106 configured to provide broadband light. The optical system may additionally include a spectrometer 108 configured to receive the broadband light emitted by the broadband light source 106 and reflected by the object for visible-near infrared-shortwave infrared (VIS-NIR-SWIR) spectroscopy of the object. The optical system may also include a hyperspectral camera 110 configured to receive the broadband light emitted by the broadband light source and reflected by the object for hyperspectral imaging (HSI) of the object. The optical system may further include a controller 112 (also referred to as processor) coupled to the plurality of light emitting diodes, the broadband light source, the charge-coupled device, the spectrometer and the hyperspectral camera.

In other words, the optical system may be an integrated optical platform capable of performing fluorescence imaging (FI), visible-near infrared-shortwave infrared (VIS-NIR-SWIR) spectroscopy, and hyperspectral imaging (HSI) of an object, such as a plant or part of a plant, such as a leaf.

For avoidance of doubt, FIG. 1 serves to illustrate some of the features present in an optical system according to various embodiments, and is not intended to limit for, instance, the arrangement, size, shapes, orientation etc. of these features.

Various embodiments may combine three imaging and sensing technologies, i.e. fluorescence imaging (FI), visible-near infrared-shortwave infrared (VIS-NIR-SWIR) spectroscopy, and hyperspectral imaging (HSI) in a single platform. Various embodiments may provide a portable and flexible integrated imaging and sensing platform to obtain continuous and multi-parametric information on morphological and internal plant traits. Various embodiments may allow non-invasive determination of plant growth information in terms of plant pigments, water and macro-nutrients to be measured quantitatively and in real-time.

The optical system may be referred to as an integrated optical system.

In various embodiments, the optical system may include a backend module. The optical system may also include a probe (also referred to as imaging probe). The optical system may further include a plurality of fibers (i.e. optical fibers) coupling the backend module and the probe. One fiber of the plurality of fibers may be configured to carry light from the broadband light source 106 in the backend module to the probe. Another fiber of the plurality of fibers may be a fluorescence imaging (FI) fiber configured to carry the reflected fluorescence imaging (FI) light, i.e. the light emitted by one or more of the plurality of light emitting diodes (LEDs) 102 and reflected by the object, to the backend module, i.e. to an optical module including the fiber collimator, the long-pass filter and the focusing lens. Yet another fiber of the plurality of fibers may be configured the reflected broadband light to the spectrometer 108 in the backend module for VIS-NIR-SWIR spectroscopy. Yet another fiber of the plurality of fibers may be configured to carry the reflected broadband light to the hyperspectral camera 110 for hyperspectral imaging (HSI).

In various embodiments, the backend module may include the broadband light source 106, the charge-coupled device (CCD) 104, the spectrometer 108, the hyperspectral camera 110, and the controller 112. The probe may include the plurality of light emitting diodes 102.

In various embodiments, the probe may configured to be mounted to a robotic arm. By mounting the probe to a robotic arm, the optical system may be suitable to be used in environments such as vertical farms in which there is a lack of space, and measurements would need to be taken by using the robotic arm.

In various embodiments, the optical system may include a light emitting diode (LED) driver. The backend module may include the light emitting diode (LED) driver configured to drive the plurality of light emitting diodes 102. The LED driver may be configured to regulate power and pulse widths to the plurality of light emitting diodes 102. The LED driver may be connected to the controller 112 and to the plurality of light emitting diodes 102. The controller 112 may be coupled to the plurality of light emitting diodes 102 via the LED driver.

During operation, i.e. during fluorescence imaging (FI), one or more of the plurality of light emitting diodes 102 may be activated or turned on. Different groups of light emitting diodes of the plurality of light emitting diodes 102 may be configured to emit light of different wavelengths, and different light emitting diodes of the plurality of light emitting diodes 102 may be activated or turned on to measure or determine levels of different substances/chemicals in the object. The object may be the plant or a part of the plant, e.g. a leaf. The leaf may, for instance, be a Chye Sim leaf or a Bok Chye leaf, as highlighted herein. However, in various embodiments, the object may be any other suitable plant part, e.g. the stem, or any other suitable object, e.g. a fungus such as a mushroom or a fruit such as blueberry.

Fluorescence imaging (FI) may be used to measure or determine chlorophyll, flavonoid and anthocyanin levels of the plant or part of the plant. The light emitting diodes configured to emit red light (e.g. about 650 nm) and green light (e.g. about 550 nm) may be used to measure or determine the anthocyanin level. The light emitting diodes configured to emit red light (e.g. about 650 nm) and ultraviolet (UV) light (e.g. 350 nm) may be used to measure or determine the flavonoid level. The light emitting diodes configured to emit blue light (e.g. 430 nm) may be used to measure or determine the chlorophyll level. The light emitted by the plurality of light emitting diodes 102 may be modulated using pulse amplitude modulation (PAM). The plurality of light emitting diodes may be arranged in one or more panels. For instance, each panel may include a light emitting diode configured to emit red light, a light emitting diode configured to emit green light, a light emitting diode configured to emit blue light, and a light emitting diode configured to emit ultraviolet light.

In various embodiments, the optical system may include an optical module. The backend module may include the optical module include a fiber collimator, a long-pass filter and a focusing lens. The fiber collimator, the long-pass filter and the focusing lens may be arranged between the plurality of fibers and the charge-coupled device (CCD) 104. The fiber collimator may be configured to receive and collimate the light that is emitted by one or more of the plurality of light emitting diodes (LEDs) 102 and reflected by the object. The long-pass filter may be configured may be configured to block wavelengths of the light received from the collimator that is shorter or equal than a predetermined cut-off wavelength while allowing wavelengths of the light that is greater than the predetermined cut-off wavelength. The focusing lens may be configured to focus the light that has passed through the long-pass filter onto the charge-coupled device (CCD) 104.

In various embodiments, the probe may include an imaging lens. The imaging lens may be configured to focus the light from the one or more of the plurality of light emitting diodes 102 or the broadband light from the broadband light source onto the object, e.g. the plant or the leaf. The imaging lens may also be configured to direct the reflected LED light (i.e. light emitted by the plurality of LEDs 102) or the reflected broadband light to the plurality of fibers.

During fluorescence imaging, depending on the substance in the plant or plant part to be determined or measured, one or more of the plurality of light emitting diodes 102 and the charge-coupled device (CCD) 104 may be activated or turned on by the controller 112. The LED light may be provided by the one or more light emitting diodes of the plurality of light emitting diodes 102 and focused by the imaging lens in the probe onto the plant or plant part. The reflected LED light from the plant or plant part may be coupled (via the optical module which may include the fiber collimator, the long-pass filter and the lens) to the charge-coupled device (CCD) 104.

During visible-near infrared-shortwave infrared (VIS-NIR-SWIR) spectroscopy, the controller 112 may activate or turn on the broadband light source 106 and the spectrometer 108. The broadband light source 106 may emit broadband light which may be coupled via the imaging lens in the probe onto the plant or plant part. The reflected broadband light from the plant may be coupled to the spectrometer 108. Visible-near infrared-shortwave infrared spectroscopy may be used to determine absorption peaks which are indicative of various parameters associated with plant growth, e.g. plant pigments, polyphenols, water and macro-nutrient levels of the plant or plant part.

During hyperspectral imaging (HSI), the controller 112 may activate or turn on the broadband light source 106 and the hyper-spectral camera 110. The broadband light source 106 may emit broadband light which may be coupled via the imaging lens in the probe onto the plant. The reflected broadband light from the plant may be coupled to the hyper-spectral camera 110. Hyperspectral imaging may be used to determine the intensity of the reflected light from the plant at various wavelengths, which may indicate nitrogen (N), phosphorous (P) and potassium (K) levels of the plant or plant part.

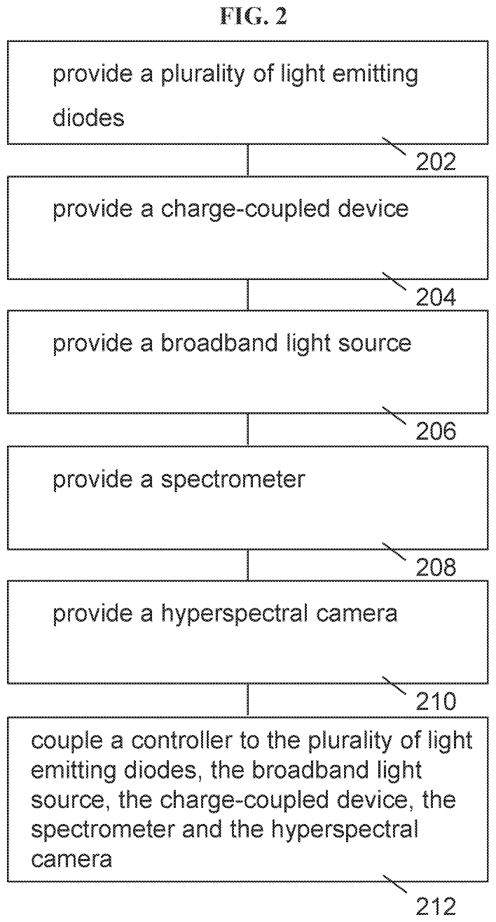

FIG. 2 is a general illustration of a method of forming an optical system according to various embodiments. The method may include, in 202, providing a plurality of light emitting diodes configured to provide light of predetermined wavelengths. The method may also include, in 204, providing a charge-coupled device configured to receive to receive the light emitted by one or more of the plurality of light emitting diodes and reflected by an object for fluorescence imaging of the object. The method may additionally include, in 206, providing a broadband light source configured to provide broadband light. The method may also include, in 208, providing a spectrometer configured to receive the broadband light emitted by the broadband light source and reflected by the object for visible-near infrared-shortwave infrared spectroscopy of the object. The method may further include, in 210, providing a hyperspectral camera configured to receive the broadband light emitted by the broadband light source and reflected by the object for hyperspectral imaging of the object. The method may also include, in 212, coupling a controller to the plurality of light emitting diodes, the broadband light source, the charge-coupled device, the spectrometer and the hyperspectral camera.

In other words, the method may include providing a plurality of light emitting diodes, a charge-coupled device, a broadband light source, a spectrometer, and providing a hyperspectral camera. The method may also include coupling a controller to the plurality of light emitting diodes, the broadband light source, the charge-coupled device, the spectrometer and the hyperspectral camera.

For avoidance of doubt, FIG. 2 is not intended to limit the sequence of the various steps. For instance, step 202 may occur before, after, or at the same time during forming or assembly of the optical system.

In various embodiments, the method may include providing a backend module. The method may also include providing a probe. The method may further include coupling a plurality of fibers to the backend module and the probe.

In various embodiments, the backend module may include the broadband light source, the charge-coupled device, the spectrometer, the hyperspectral camera, and the controller.

In various embodiments, the probe may include the plurality of light emitting diodes.

In various embodiments, the backend module may include a light emitting diode driver configured to drive the plurality of light emitting diodes.

In various embodiments, the backend module may include an optical module including a fiber collimator, a long-pass filter and a focusing lens.

In various embodiments, the probe may include an imaging lens.

In various embodiments, the plurality of light emitting diodes may be arranged in one or more panels.

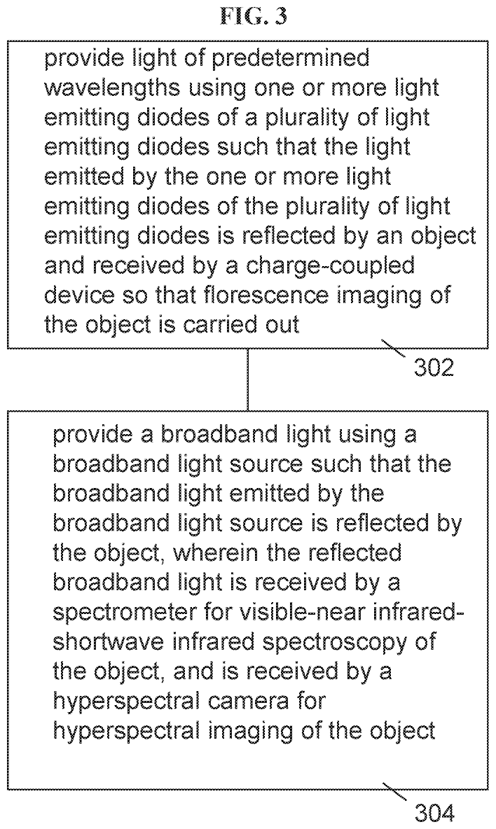

FIG. 3 is a general illustration of a method of operating an optical system according to various embodiments. The method may include, in 302, providing light of predetermined wavelengths using one or more light emitting diodes of a plurality of light emitting diodes such that the light emitted by the one or more light emitting diodes of the plurality of light emitting diodes is reflected by an object and received by a charge-coupled device for fluorescence imaging of the object. The method may also include, in 304, providing a broadband light using a broadband light source such that the broadband light emitted by the broadband light source is reflected by the object, wherein the reflected broadband light is received by a spectrometer for visible-near infrared-shortwave infrared spectroscopy of the object, and is received by a hyperspectral camera for hyperspectral imaging of the object.

In other words, the optical system may be used for fluorescence imaging, visible-near infrared-shortwave infrared spectroscopy, and hyperspectral imaging of an object such as a plant or part of the plant, e.g. a leaf of the plant.

For avoidance of doubt, FIG. 3 is not intended to limit the sequence of the various steps. For instance, step 302 may occur before, after or at the same time as step 304.

Fluorescence imaging may be used to measure chlorophyll, flavonoid and anthocyanin levels of the plant or part of the plant. On the other hand, visible-near infrared-shortwave infrared spectroscopy may be used to determine plant pigments, polyphenols, water and macro-nutrient levels of the plant. Hyperspectral imaging may be used to determine nitrogen, phosphorous and potassium levels of the plant.

Various embodiments may relate to an integrated non-invasive, non-contact optical sensing and imaging platform using fluorescence imaging, hyperspectral imaging, visible (VIS)-near infrared (NIR) and shortwave infrared (SWIR) spectroscopy for plant phenotyping in terms of its growth and photosynthesis process is proposed. Parameters that can be quantitatively evaluated are plant stress, growth, pigments, polyphenols, water and macronutrients etc. The advantage of this integrated optical sensor and imaging solution for plant phenotyping may be that above-mentioned parameters can be quantified continuously, in wide-field and real-time in a non-contact and non-destructive mode.

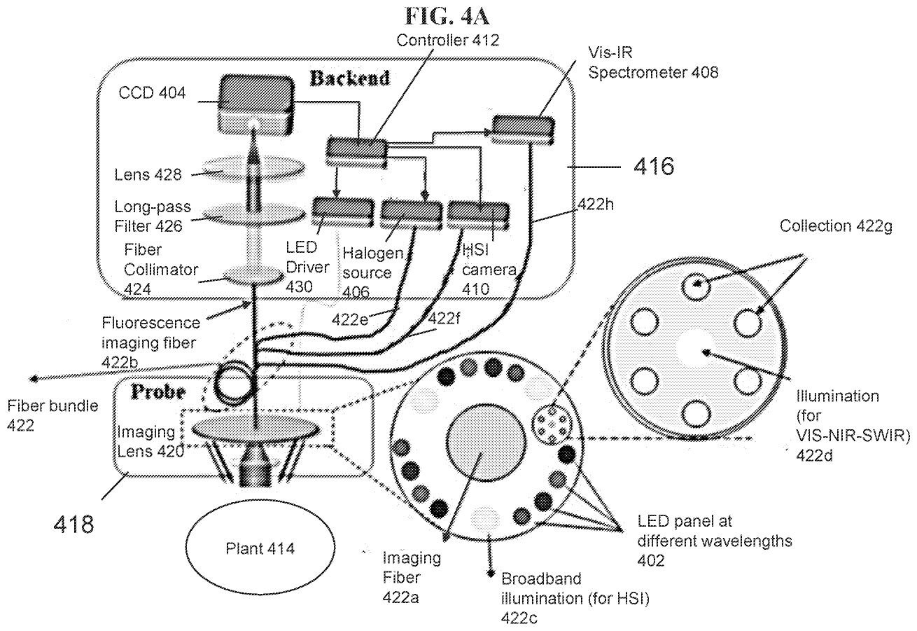

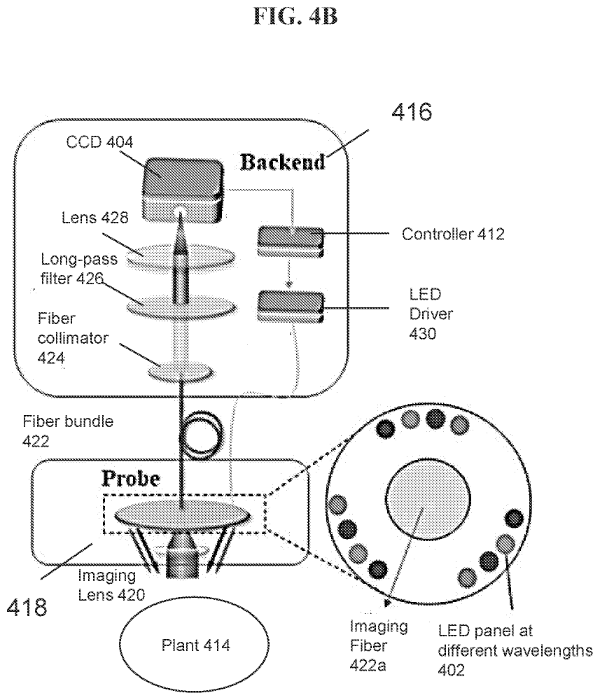

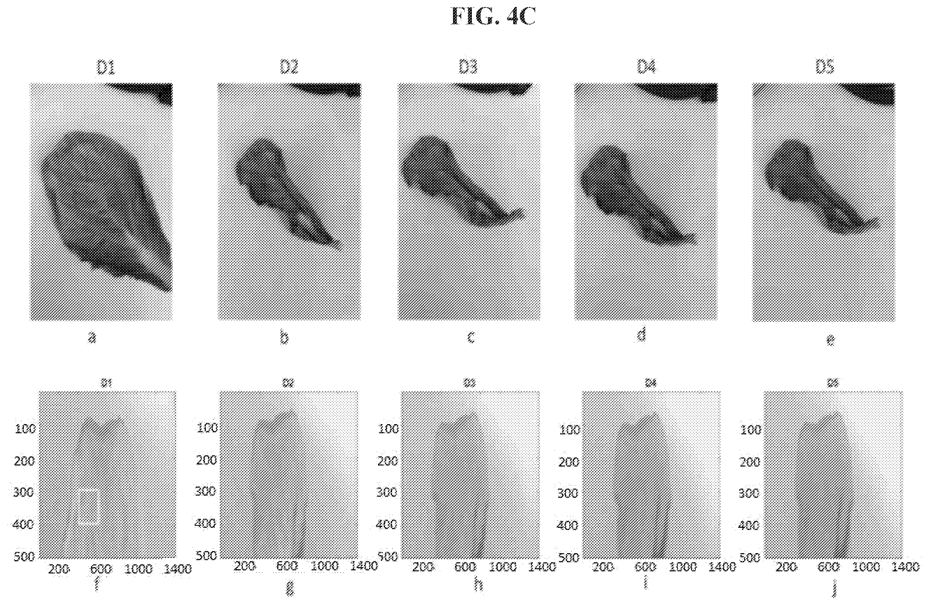

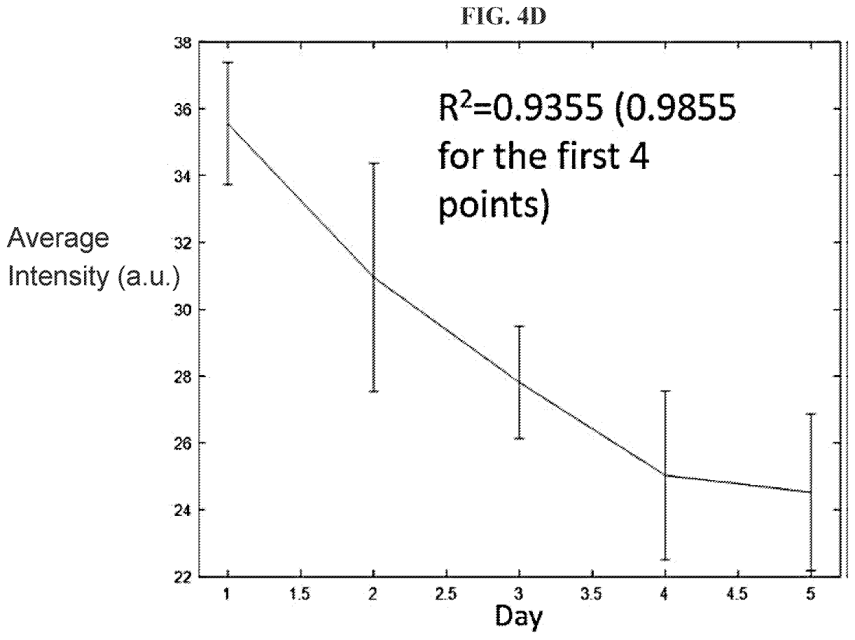

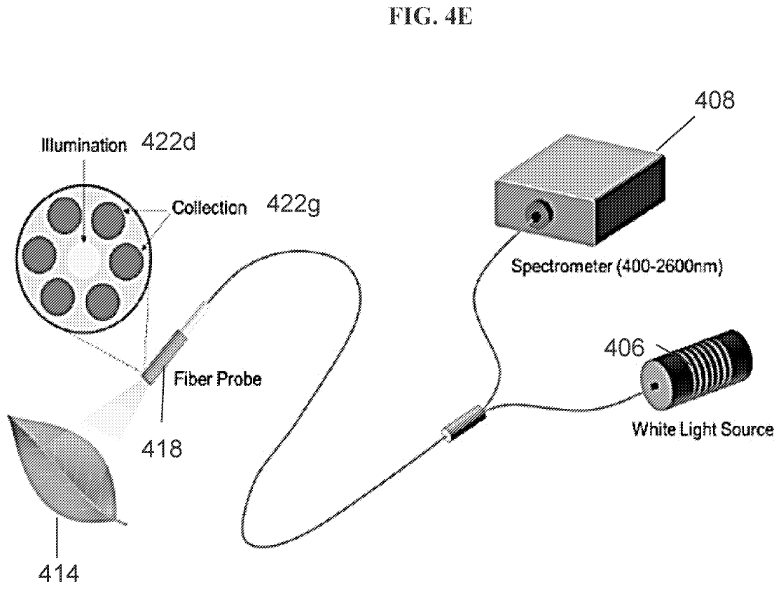

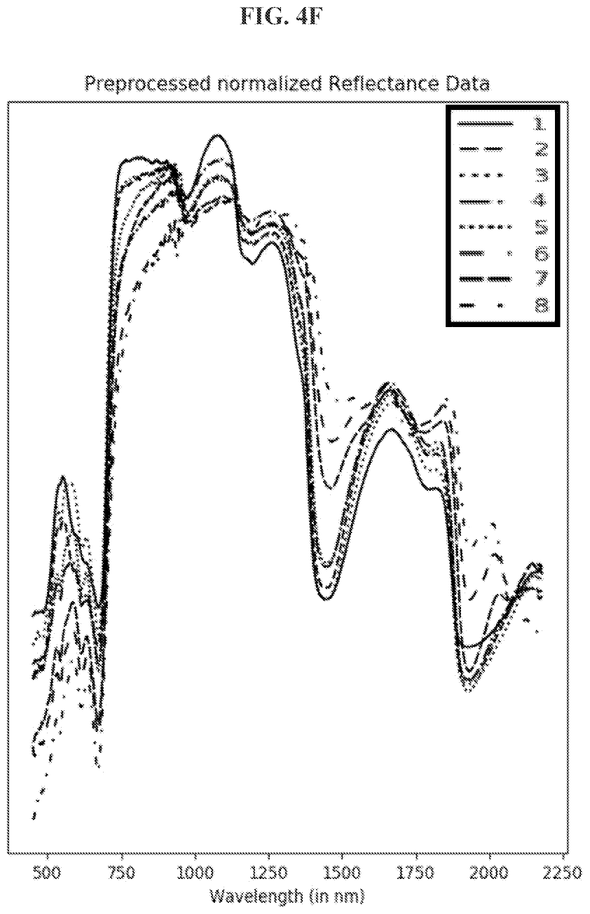

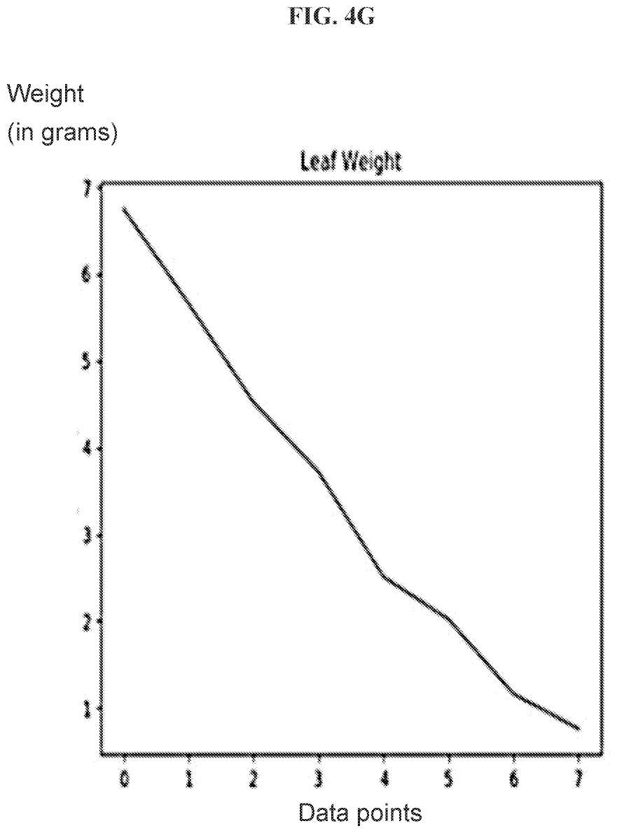

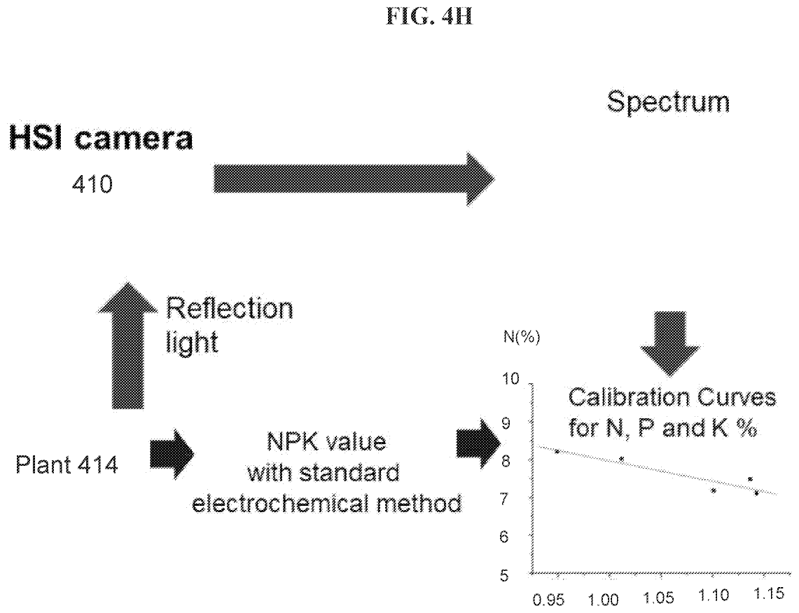

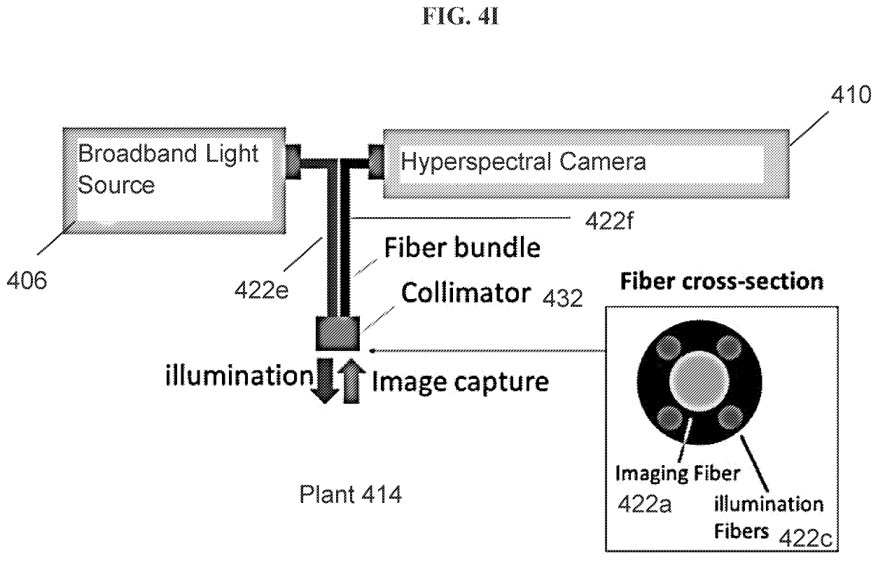

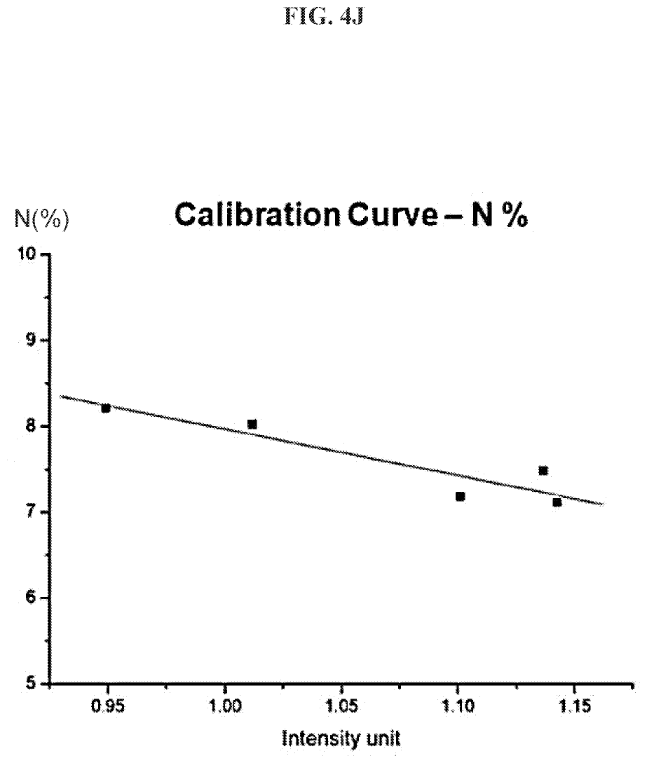

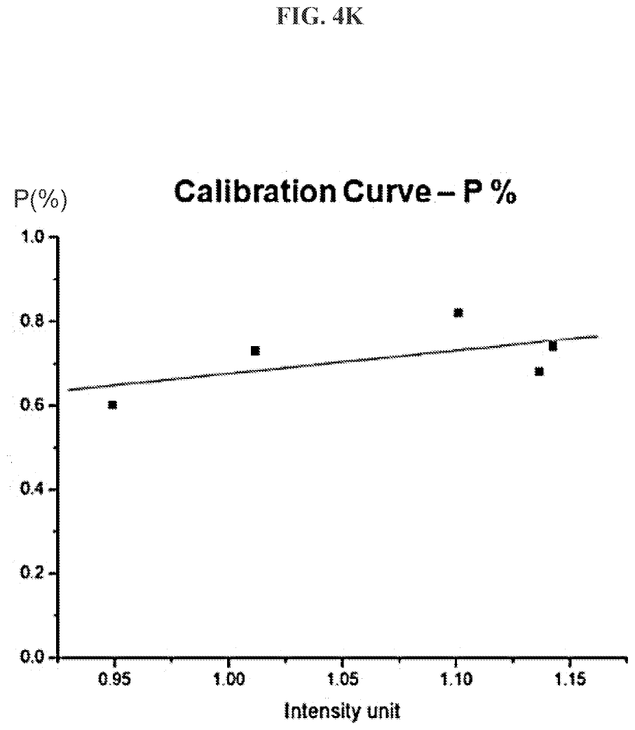

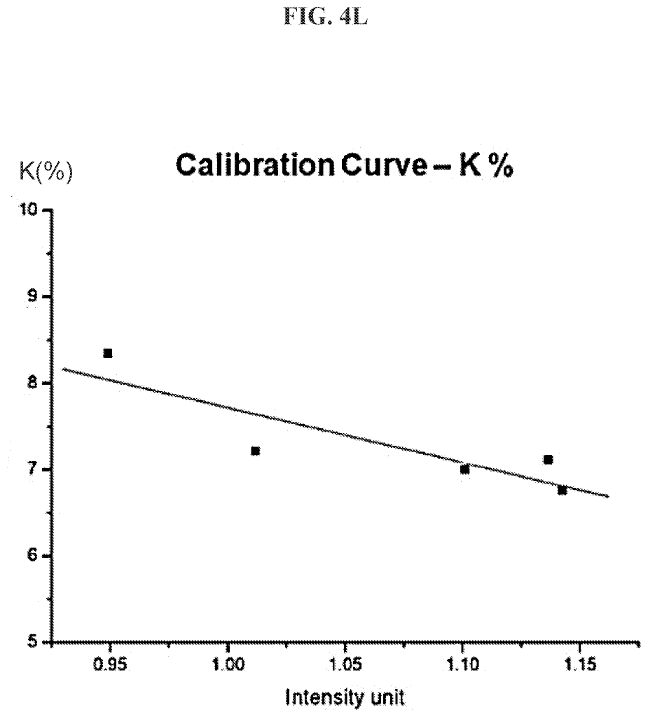

FIG. 4A shows a schematic of the integrated optical system according to various embodiments for plant phenotyping. As highlighted above, the optical system may include three parts: a fluorescence imager, a VIS-NIR-SWIR spectroscopy sensor and a hyperspectral imager.

The optical system may include a plurality of light emitting diodes configured to provide light of predetermined wavelengths. The light emitting diodes may be arranged as LED panels 402, with each LED panel 402 including light emitting diodes of different wavelengths. The optical system may also include a charge-coupled device (CCD) 404 configured to receive the light emitted by one or more light emitting diodes of the plurality of light emitting diodes (LEDs) and reflected by an object, such as a plant or plant part 414, e.g. a leaf, for fluorescence imaging (FI) of the plant or plant part 414. The optical system may further include a broadband light source, such as a halogen source 406 configured to provide broadband light. The optical system may additionally include a spectrometer 408 configured to receive the broadband light emitted by the broadband light or halogen source 406 and reflected by the plant or plant part 414 for visible-near infrared-shortwave infrared (VIS-NIR-SWIR) spectroscopy of the plant or plant part 414. The optical system may also include a hyperspectral or hyperspectral imaging (HSI) camera 410 configured to receive the broadband light emitted by the broadband light or halogen source 406 and reflected by the plant or plant part 414 for hyperspectral imaging (HSI) of the plant or plant part 414. The optical system may further include a controller 412 coupled to the plurality of light emitting diodes (i.e. the LED panels 402), the broadband light or halogen source 406, the charge-coupled device 404, the spectrometer 408 and the hyperspectral or hyperspectral imaging (HSI) camera 410.

The relatively bulky components, such as the charge-coupled device 404, the controller 412, the spectrometer 408 and the HSI camera 410 may be placed in a backend module 416, while other components such as the LED panels 402 and the imaging lens 420 may be arranged in the probe 418 to achieve flexibility. The backend module and the probe may be coupled by a plurality of fibers (i.e. fiber bundle 422). Such a flexible integrated design based on fiber optics may have advantages in specific controlled environments, such as vertical farms, where there is a deficiency of space and measurements need to be done on higher altitudes with the help of a robotic arm.

The inset of FIG. 4A shows a cross-section of the probe 418. The probe may include the LED panels 402 arranged around an imaging fiber 422a. The imaging fiber 422a may be configured to couple reflected LED light from the plant or plant part 414 to the charge-coupled device 404 via the fluorescence imaging fiber 422b coupled to the imaging fiber 422a. The reflected LED light may be coupled from the fluorescence imaging fiber 422b to an optical module including a fiber collimator 424, a long-pass filter 426 and a focusing lens 428 before being focused onto the charge-coupled device 404. The LED panels 402 may be connected to a LED driver 430, which in turn is connected to the controller 412.

The probe may also include fiber 422c which carries broadband light for hyperspectral imaging (HSI), as well as fiber 422d which carries broadband light for VIS-NIR-SWIR spectroscopy. The fibers 422c, 422d may be coupled to fiber 422e, which carries the broadband light from halogen source 406.

The image fiber 422a may be coupled to fiber 422f, which in turn is coupled to the HSI camera 410. Fibers 422a, 422f may be used for carrying reflected broadband light to the HSI camera 410 for hyperspectral imaging (HSI) of the plant 414.

As shown in FIG. 4A, the probe may also include collection fibers 422g arranged around fiber 422d. The collection fibers 422g may be coupled via fiber 422h to spectrometer 408 for VIS-NIR-SWIR spectroscopy.

The optical system may allow for sequential measurements using three different modalities, i.e. fluorescence imaging (FI), hyperspectral imaging (HSI), and visible-near infrared-shortwave infrared (VIS-NIR-SWIR) spectroscopy.

FIG. 4B is a schematic showing the optical system being used for fluorescence imaging according to various embodiments. Fluorescence analysis is an important tool for the plant's photosynthetic activity and stress monitoring. However, conventional fluorescence imagers for plant monitoring are not flexible for applications like indoor vertical farming, due to the large size of the imaging probe. The optical system shown in FIG. 4A may be used for fluorescence imaging. As highlighted above, the optical system may include two parts, i.e. an imaging probe 418 and a backend module 416. The probe 418 may include an imaging lens 420 and LED panels or arrays 402 with multiple wavelengths (UV, blue, green and red) for chlorophyll, flavonoids and anthocyanin index measurements. An imaging fiber bundle 422 may be used to collect the reflected fluorescence from the plant leaf. As highlighted above, the reflected fluorescence from the plant may be coupled via image fiber 422a and fluorescence imaging fiber 422b to the backend module 416.

As also highlighted above, the backend module 416 may include a lens 428 and optical filter 426 in front of the charge-coupled device (CCD) 404 to capture the image. The controller 412 may be used to control the CCD 404 and the LED driver 430, and may also perform real-time data processing. The probe 418 may be compact, flexible, and may be hand-held or mounted on a robotic arm, while the backend module 416 of the system can be placed in a backpack or on a benchtop.

In order to minimize or reduce the ambient light interference due to Kautsky effect, pulse amplitude modulation (PAM) may be adopted to record the chlorophyll fluorescence induction curve. Red and green lights may be used for anthocyanin measurement. Red and UV light may be used for flavonoid measurement. Fluorescence signal ratios of these combinations may be calibrated and correlated to the chemical compounds respectively. Blue light may be used to record chlorophyll related photosynthetic activity and infer plant stress. Measuring and saturation light may be pulse-modulated. Saturation pulse may be set to be much stronger than measuring pulse. Minimal fluorescence after dark adaption F₀, maximal fluorescence Fₘ when all Photosystem II reaction centers are closed, minimal fluorescence light-adapted sample F₀′ and the corresponding maximal fluorescence Fₘ′ can be measured to evaluate efficiency of Photosystem IL, photochemical/non-photochemical quenching, and plant stress.

A preliminary experiment has been done to qualitatively monitor a Chye Sim leaf fluorescence change in an indoor setting. FIG. 4C shows (a)-(e) photographs of a Chye Sim leaf taken from Day 1 to Day 5, and (f)-(j) the corresponding fluorescence images (750±20 nm) images using the charge-coupled device (CCD) 404 of the optical system according to various embodiments. The leaf was kept in 28 V room temperature with natural sunlight for 5 days. Images were taken by the CCD 404 with 750±20 nm band-pass filter in front of it. White light source of 400-700 nm was used on the leaf (placed on a white paper), as shown in FIG. 4C. The averaged intensity of the pixels marked by the white square was extracted for each of the images to quantify the emitted fluorescence signal. The linearly fitted intensity curve over the 5 days was shown in FIG. 4D with an R² value of 0.9355 indicating the decrease in chlorophyll and other chromophores as the leaf dies. FIG. 4D shows a plot of average intensity (in arbitrary units or a.u.) as a function of day illustrating the variation of the average intensity of the fluorescence images according to various embodiments. It can also be seen that from Day 4 onwards, the decreasing rate slowed down significantly and reached saturation. Without Day 5's data, the R² value is 0.9855, indicating good linearity.

Plant phenotyping is a rapidly emerging research area concerned with the quantitative measurement of the structural and functional properties of plants. The reflectance of light from plants is a complex phenomenon, which is dependent on multiple biophysical and biochemical interactions. Optical sensors are promising tools for non-invasive plant disease detection and diagnosis. During pathogenesis, leaf pathogens may influence leaf structural properties as well as chemical properties, thereby also altering the optics for detecting and diagnosing plant disease. Changes in reflectance due to plant pathogens and plant diseases can be explained by impairments in the leaf structure and chemical composition of the tissue during pathogenesis.

FIG. 4E is a schematic showing the optical system being used for visible-near infrared-shortwave infrared (VIS-NIR-SWIR) spectroscopy according to various embodiments. In optical spectroscopy, a reflection from the sample, i.e. the plant or plant part 414, may be analysed when it is illuminated with a broadband white light source 406. Optical spectroscopy is the direct fingerprint of the absorption phenomenon by the plant or plant part 414, and may capture changes in structural and chemical properties of the plant or plant part 414.

Initial VIS-NIR-SWIR spectroscopy experiments have been conducted to investigate the effect of reduced water content in Bok Chye leaves utilizing advanced chemometrics methods.

Four Bok Chye leaves were heated in an oven at 80° C. every day for 4 days and the weight in grams was noted before and after drying. The VIS-NIR-SWIR spectra from the leaves were acquired at five different locations on the leaves. Thus, eight data points were collected from one of these four Bok Chye leaves over four days.

FIG. 4F is a plot of normalized reflectance as a function of wavelength (in nanometer or nm) showing the visible-near infrared-shortwave infrared (VIS-NIR-SWIR) spectra collected over four days at eight different weight data points by the optical system according to various embodiments before and after heat treatment from one of the Bok Chye leaves.

The eight different weight data points are illustrated by FIG. 4G. FIG. 4G is a plot of weight (in grams or gins) as a function of weight data points showing the weight of the Bok Chye leaf at different weight data points. FIG. 4G shows a linear decrement in the weight of the same Bok Chye leaf due to its heat treatment. It is evident from FIG. 4F that the drying process of the leaf had reduced the water content and led to structural changes owing to the change in colour of the leaf. Thus, the reflectance changes are clearly visible in the 800-1000 nm, and around the 1450 nm and 1900 nm wavelength regions. The near-infrared wavelength regions around 1450 nm and 1900 nm are well documented as relating to the water absorption peak.

A regression model may be developed with the help of acquired VIS-NIR-SWIR spectra and the associated change in the weight of Bok Chye leaf with the help of principle component analysis (PCA) and linear regression model (combined polymerase chain reaction (PCR)). Since reflectance from plant leaf at all wavelengths does not attribute to the changes in the water content, PCA is used for dimensionality reduction, and is further utilized for constructing a regression model. This regression model may show an accuracy above 98% to predict the weight of Bok Chye leaf with the help of only the reflectance spectrum signature. This signifies that with an adequate regression model in place, by just measuring the reflectance spectrum from the plant leaf under interrogation, its growth parameters in terms of water content can be evaluated non-invasively in almost real-time.

Current imaging methods for indoor vegetable farms, such as thermographic cameras, can only provide basic morphology and plant health status data. In addition, there is no commercially available imaging system for the measurement of different macro-nutrient contents of plant vegetables simultaneously, e.g. nitrogen (N), phosphorus (P) and potassium (K), although the information of these macro-nutrient contents is essential in plant health monitoring.

FIG. 4H is a schematic showing a method of determining different macro-nutrient contents of the plant 414 according to various embodiments. The method may use the hyperspectral camera 410 of the optical system to analyse or determine the intensity of reflection light from the leaf of plant or plant part 414 at 450 nm, 550 nm, 650 nm and 780 nm wavelengths. The intensity index may be correlated with the N, P and K percentage (%) values measured with the standard electrochemical method. Linear equations can be obtained from the curves for real-time conversion from intensity index to N, P and K percentage values.

FIG. 4I is a schematic showing the optical system being used for hyperspectral imaging (HSI) according to various embodiments. With the hyperspectral imaging set-up described in FIG. 4I, the reflection spectral images of Bok Chye leaf samples have been recorded at 450 nm, 550 nm, 650 nm and 780 nm wavelengths. Then, the intensity values at all four wavelengths are integrated into one single value: the HSI intensity parameter. During the experiment, the measurements for 5 different Bok Chye samples were repeated, and 5 HSI intensity values were obtained. Then, the standard electrochemical method was performed with the same samples to determine the nitrogen (N) percentage (%), the phosphorous (P) percentage (%), and the potassium (K) percentage (%) content values. Finally, three different calibration curves for the N %, P % and K % contents of the Bok Chye leaf samples were constructed with the data from both methods (see FIGS. 4J-L). FIG. 4J is a plot of nitrogen (N) percentage (%) as a function of intensity unit (arbitrary units) showing the measured calibration curve for nitrogen in the leaf sample according to various embodiments. FIG. 4K is a plot of phosphorous (P) percentage (%) as a function of intensity unit (arbitrary units) showing the measured calibration curve for phosphorous in the leaf sample according to various embodiments. FIG. 4L is a plot of potassium (K) percentage (%) as a function of intensity unit (arbitrary units) showing the measured calibration curve for potassium in the leaf sample according to various embodiments.

The calibration curve equations allow the estimation of N %, P % and K % of leaf sample with a single hyperspectral image in future experiments. The accuracy (correlation coefficient) for N %, P % and K % content detection were 0.92, 0.57 and 0.87 respectively. The correlation coefficient value can be further improved through (1) measurements with an increased number of sample size, and (2) further measurements conducted with live plants.

Various embodiments may relate to a fiber-based integrated platform that is used for plant phenotyping (including important parameters such as plant pigments, macro-nutrients, water content etc.) allowing sequential measurement using three optical sensing and imaging technologies.

Plant stress, pigments and macro-nutrients etc. can be estimated simultaneously with the minimized ambient light influence.

The system may be portable and flexible, facilitating applications for both indoor and outdoor farming. It may also allow integration to a robotic arm.

Various embodiments may be based on non-contact, non-destructive optical sensor and imaging modalities.

Various embodiments may be used for real-time, continuous quantitative measurement of plant growth.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples.

1. An optical system comprising:
a plurality of light emitting diodes configured to provide light of predetermined wavelengths;
a charge-coupled device configured to receive the light emitted by one or more light emitting diodes of the plurality of light emitting diodes and reflected by an object for fluorescence imaging of the object;
a broadband light source configured to provide broadband light;
a spectrometer configured to receive the broadband light emitted by the broadband light source and reflected by the object for visible-near infrared-shortwave infrared spectroscopy of the object;
a hyperspectral camera configured to receive the broadband light emitted by the broadband light source and reflected by the object for hyperspectral imaging of the object; and
a controller coupled to the plurality of light emitting diodes, the broadband light source, the charge-coupled device, the spectrometer and the hyperspectral camera.

2. The optical system according to claim 1, further comprising:
a backend module;
a probe; and
a plurality of fibers coupling the backend module and the probe.

3. The optical system according to claim 2, wherein the backend module comprises the broadband light source, the charge-coupled device, the spectrometer, the hyperspectral camera, and the controller.

4. The optical system according to claim 2, wherein the probe comprises the plurality of light emitting diodes.

5. The optical system according to claim 2, wherein the backend module comprises a light emitting diode driver configured to drive the plurality of light emitting diodes.

6. The optical system according to claim 2, wherein the backend module comprises an optical module comprising a fiber collimator, a long-pass filter and a focusing lens.

7. The optical system according to claim 2, wherein the probe comprises an imaging lens.

8. The optical system according to claim 1, wherein the plurality of light emitting diodes is arranged in one or more panels.

9. A method of forming an optical system, the method comprising:
providing a plurality of light emitting diodes configured to provide light of predetermined wavelengths;
providing a charge-coupled device configured to receive the light emitted by one or more light emitting diodes of the plurality of light emitting diodes and reflected by an object for fluorescence imaging of the object;
providing a broadband light source configured to provide broadband light;
providing a spectrometer configured to receive the broadband light emitted by the broadband light source and reflected by the object for visible-near infrared-shortwave infrared spectroscopy of the object;
providing a hyperspectral camera configured to receive the broadband light emitted by the broadband light source and reflected by the object for hyperspectral imaging of the object; and
coupling a controller to the plurality of light emitting diodes, the broadband light source, the charge-coupled device, the spectrometer and the hyperspectral camera.

10. The method according to claim 9, the method comprising:
providing a backend module;
providing a probe; and
coupling a plurality of fibers to the backend module and the probe.

11. The method according to claim 10, wherein the backend module comprises the broadband light source, the charge-coupled device, the spectrometer, the hyperspectral camera, and the controller.

12. The method according to claim 10, wherein the probe comprises the plurality of light emitting diodes, and/or wherein the probe comprises an imaging lens.

13. The method according to claim 10, wherein the backend module comprises a light emitting diode driver configured to drive the plurality of light emitting diodes.

14. The method according to claim 10, wherein the backend module comprises an optical module comprising a fiber collimator, a long-pass filter and a focusing lens.

15. (canceled)

16. The method according to claim 9, wherein the plurality of light emitting diodes is arranged in one or more panels.

17. A method of operating an optical system, the method comprising:
providing light of predetermined wavelengths using one or more light emitting diodes of a plurality of light emitting diodes such that the light emitted by the one or more light emitting diodes of the plurality of light emitting diodes is reflected by an object and received by a charge-coupled device for fluorescence imaging of the object; and
providing a broadband light using a broadband light source such that the broadband light emitted by the broadband light source is reflected by the object, wherein the reflected broadband light is received by a spectrometer for visible-near infrared-shortwave infrared spectroscopy of the object, and is received by a hyperspectral camera for hyperspectral imaging of the object;
wherein the optical system comprises a controller coupled to the plurality of light emitting diodes, the broadband light source, the charge-coupled device, the spectrometer and the hyperspectral camera.

18. The method according to claim 17, wherein the object is a plant.

19. The method according to claim 18, wherein fluorescence imaging is used to measure chlorophyll, flavonoid and anthocyanin levels of the plant.

20. The method according to claim 18, wherein visible-near infrared-shortwave infrared spectroscopy is used to determine plant pigments, polyphenols, water and macro-nutrient levels of the plant.

21. The method according to claim 18, wherein hyperspectral imaging is used to determine nitrogen, phosphorous and potassium levels of the plant.
